(19) United States
(12) Patent Application Publication
(10) Pub. No.: US 2023/0012948 A1
(43) Pub. Date: Jan. 19, 2023

(54) ENHANCED SECURITY RIDE SERVICES SUBSCRIPTION DELIVERY SYSTEM

(71) Applicants: Hafez Omar Nesnas, Alpharetta, GA (US); Yousef Eldeib, Alpharetta, GA (US)

(72) Inventors: Hafez Omar Nesnas, Alpharetta, GA (US); Yousef Eldeib, Alpharetta, GA (US)

(21) Appl. No.: 17/375,623

(22) Filed: Jul. 14, 2021

(51) Int. Cl. G06Q 50/30; G06Q 20/12

(52) U.S. Cl. CPC G06Q 50/30; G06Q 20/127

(57) ABSTRACT

A method includes receiving a ride request message at a ride share terminal processor, the message including passenger identity information, destination information, pickup localization information, and payment credential information. The ride share delivery system finds an available driver matching the passenger's request, which may include driver gender. The system determines whether the driver has purchased a monthly driver subscription or individual credits to receive the passenger match and transmits the passenger request to the driver. Responsive to receiving a driver acceptance message, the system forwards trip information to a payment processor that includes the passenger identity information and the payment credential information. After passenger drop off, the system receives a trip payment confirmation message indicative that a payment was made from a passenger payment account directly to a driver payment account. The full amount charged to the passenger routed from the passenger's payment account to the driver's payment account.

### CROSS-REFERENCE TO RELATED APPLICATION

This application claims the benefit of U.S. Provisional Patent App. No. 63/051,848 filed on Jul. 14, 2020, which is incorporated by reference herein in its entirety.

### TECHNICAL FIELD

The present disclosure relates to transportation delivery systems, and more particularly, to mobile device processing and distributed systems configured to deliver enhanced security ride share access to passengers and a service subscription platform to drivers.

### BACKGROUND

Mobility on Demand (MoD) platforms match providers of on-demand transportation services to passengers through cloud-based computing platforms. Mobile devices and other computers may be used to match drivers (the service providers) with passengers (the customers seeking on-demand transportation).

Conventional MoD platforms provide a service to both the drivers providing the transportation services and vehicle(s) and passengers who request and pay for the transportation services. Drivers often work with or for the MoD platform provider as a contractor or an employee, and provide transportation services to the passenger by responding to a passenger transportation request received from the MoD platform. In conventional driver/passenger transportation service platforms, the MoD platforms charge the passenger for the trip, and keep a portion of the amount paid as a service provider fee. The amount provided to the driver is less than the amount paid by the passenger, which may increase costs to the passengers, and decrease revenue earned by the drivers.

Moreover, conventional MoD platforms do not include enhanced security features for their passengers by matching female drivers with passengers requesting them. Conventional MoD platforms may not further include in-vehicle enhance security for all passengers, such as real-time video feed taken from the vehicle interior then stored in the cloud. Local video storage may be subject to damage, loss, or tampering. In other aspects, some female passengers may feel less-than secure if their driver is not another female, especially at night or in unfamiliar areas. This may be because of personal preference or cultural practice.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example ride share user and driver experience using conventional ride share platforms.

FIG. 2 illustrates an example computing environment for practicing embodiments in accordance with the present disclosure.

FIG. 3 is a functional schematic of an example computing architecture for a cloud-based sever computer system and cloud computing environment in accordance with embodiments of the present disclosure.

FIG. 4 depicts a plurality of functional abstraction layers provided by the cloud computing environment of FIG. 3 in accordance with the present disclosure.

FIG. 5 depicts an example driver database in accordance with the present disclosure.

FIG. 6 depicts a flow diagram of an example method for delivering transportation services using a security enhanced ride share platform in accordance with the present disclosure.

### DETAILED DESCRIPTION

### Overview

The systems and methods disclosed herein are configured and/or programmed to provide shared ride transportation services to passengers requesting on-demand transportation, and available drivers that wish to be matched with customers. In some embodiments, a method includes receiving a ride request message sent by a passenger mobile device at a ride share terminal processor. The ride request message may include passenger identity information, destination information, pickup localization information, and payment credential information. The ride share delivery system may locate an available driver matching the passenger's request, which may include driver gender, vehicle type or class, and other details. In one example embodiment, the system provides a monthly subscription in which drivers may pay the ride share terminal processor a fixed fee for a calendar month of access to available passengers requesting transportation. In another example embodiment, the system may provide a number of pre-paid credits to the drivers, where the driver can purchase one or more credits in advance. In some embodiments, each purchased credit has a fixed cost that does not change with respect to the distance traveled when servicing the passengers (e.g., a fixed fee for every match). The drivers may therefore purchase one or more credits for which a single trip (or passenger match) is provided to the driver.

In some embodiments, the system determines whether the driver has purchased a monthly driver subscription or individual credits to receive the passenger match and transmits the passenger request to the driver. The driver may either accept the passenger and proceed to navigate toward the passenger pickup location included in the ride share request message, or decline the match by interacting with a user-selectable interface as part of a ride share application instantiated on the driver's mobile or other computing device.

In one example embodiment, the driver confirmation is sent from the driver device to the ride share terminal operator device (e.g., a server connected to the driver mobile device application via a distributed cloud computing platform). Responsive to receiving a driver acceptance message, the system forwards trip information to a payment processor that includes the passenger identity information and the payment credential information. After passenger drop off, the system receives a trip payment confirmation message indicative that a payment was made from a passenger payment account directly to a driver payment account. The full amount charged to the passenger routed from the passenger's payment account to the driver's payment account.

In one example embodiment, the present disclosure can be used to provide enhanced security features that provide increased security for vulnerable passengers, and for passengers that prefer to be picked up by a female driver. The drivers may also prefer to be matched with female passengers for similar reasons. The system may match drivers and passengers according to respective preferences, which can increase comfort and security for both the driver and passenger.

In another example embodiment, the system may include one or more in-vehicle video recording devices, where the system saves a real-time video feed of the vehicle interior in a secured (encrypted or non-encrypted) cloud storage location. This feature may increase the reliability of the stored video by keeping the video feed free from erasure, tampering, or other practices.

According to another example embodiment, the system may charge the passenger payment account through a payment processor, and receive a payment confirmation responsive to dropping off a passenger associated with the passenger device at a location associated with the destination information. The trip payment confirmation message may indicate that a payment was made from a passenger payment account to a driver payment account.

In one example embodiment, the trip payment confirmation message may indicate that all funds charged to the passenger payment account are deposited to the driver payment account. Accordingly, no funds charged to the passenger payment account may be paid to a ride share terminal operator account associated with a ride share terminal operator, which can increase revenue for the driver and provide the best value to the passenger paying the transportation fee.

According to another example embodiment, the passenger identity information may also include information indicative that the passenger is female. In this example embodiment, the ride request message may further include a female driver request for a female driver. The system may send the passenger request to only those drivers that are within the geographic region (e.g., a geofence region having a predetermined radius from the passenger pick up location) that match other requirements sent in the ride share request such as driver gender. This aspect may increase the feeling and experience of security for vulnerable or other types of passengers.

According to another aspect of the present disclosure, the system may direct all transportation fees received from the passenger to the driver's payment account without directing any funds for the transaction to the ride share terminal operator payment account. Instead, the ride share terminal operator may receive funds based on a fixed fee paid by the driver for a monthly provider subscription that allows the subscribing driver to pay a fee for an unlimited number of passenger matches during a calendar month.

According to another embodiment, the ride share terminal operator may receive funds based on a fixed fee paid by the driver for a single ride share trip. Accordingly, in one example embodiment, the system may provide a driver credit usable for providing a single ride responsive to receiving payment from the driver in a ride share terminal operator payment account. In some aspects, a driver profile database may be maintained by the ride share service terminal processor, which may include driver information including background and biographical information, as well as a ledger that accounts for the number of pre-purchased credits. The driver may interact with the ride share terminal processor through a mobile device application and purchase a number of ride share provider credits.

In some embodiments, determining the driver subscription status can include determining, via the processor, that a driver profile associated with the driver includes one of a value indicative that the driver has purchased a trip credit to provide transportation to the passenger, or a datum indicative that the driver is a monthly subscriber having a monthly subscription that provides an unlimited number of transportation services during a calendar month. The terminal processor may receive a driver request to purchase the trip credit allowing the driver to provide a single transportation service.

In other aspects, the terminal operator processor may receive, from the payment processor device, a trip credit payment confirmation message indicative that a trip credit payment was made from the driver payment account to a ride share terminal operator account responsive to a successful driver payment by the driver. The processor may update a driver profile dataset associated with the driver with the trip credit based on the trip credit payment confirmation message, wherein updating includes adding a trip credit value to show an additional paid trip credit. The terminal operator processor may remove (e.g., decrement) the trip credit from the driver profile responsive to receiving the trip payment confirmation message, which means that a passenger was successfully picked up, dropped off at their requested destination, and payment was made directly from the passenger payment account to the driver payment account.

Aspects of the present disclosure describe systems and methods that provide enhanced security for passengers and ride share drivers. Moreover, disclosed systems and methods may improve the experience of receiving and providing transportation services for both the passengers and drivers that wish to earn a higher respective income from their work.

These and other advantages of the present disclosure are provided in greater detail herein.

### ILLUSTRATIVE EMBODIMENTS

The disclosure will be described more fully hereinafter with reference to the accompanying drawings, in which example embodiments of the disclosure are shown, and not intended to be limiting.

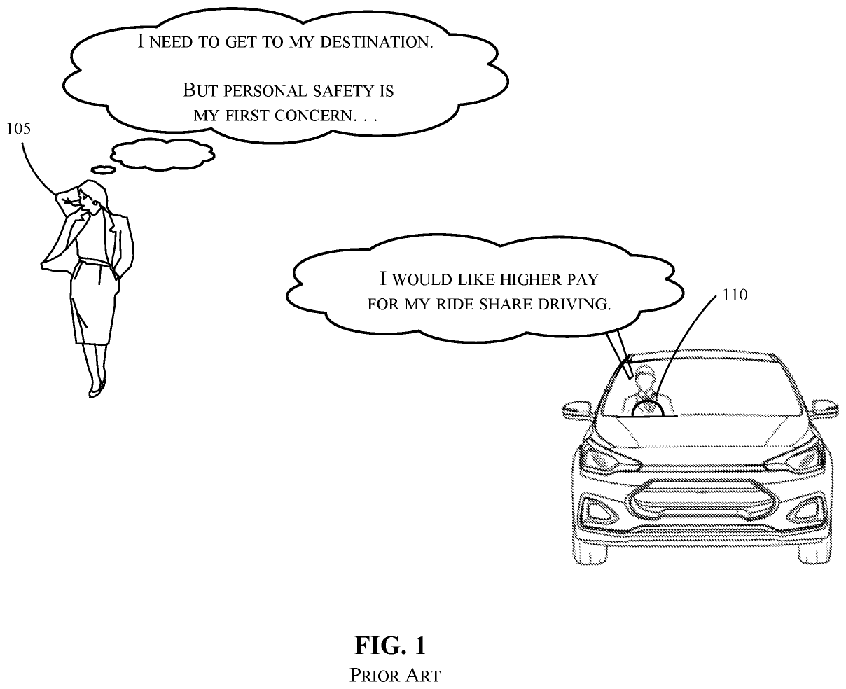

FIG. 1 depicts an example ride share user and driver experience using conventional ride share platforms. An example ride share passenger 105 is shown, thinking about her needs: she indicates that transportation services are needed, but also has concerns about personal safety. As explained above, some passengers may experience security concerns when a male driver picks them up. These concerns may be amplified at times during evening hours, or when the ride share passenger 105 is in an unfamiliar area.

Drivers, such as the ride share driver 110 illustrated in FIG. 1, may also have concerns about providing ride share driving services to a MoD platform that retains some of the fare revenue as their fee. This means that the ride share driver 110 may receive only a portion of the fees paid by the passengers. The ride share driver 110 is shown in FIG. 1 expressing a concern that he/she would like higher pay for providing his ride share driving services.

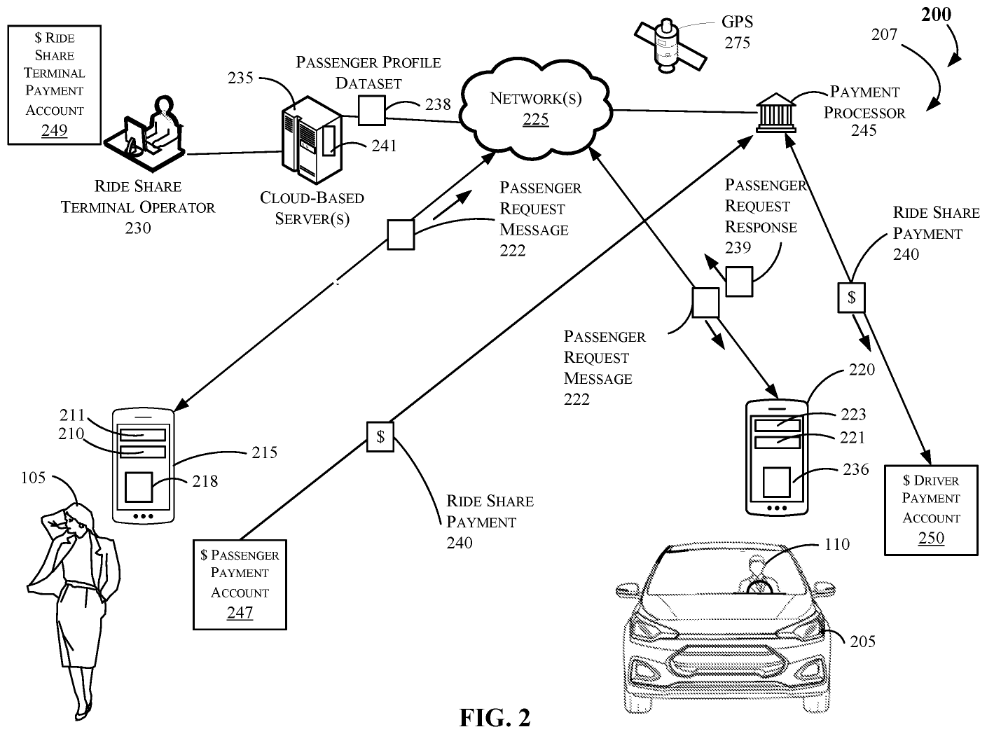

It may be advantageous, therefore, to provide systems and methods for delivering enhanced security transportation services via a distributed computing platform. FIG. 2 illustrates an example computing environment for practicing one or more embodiments, in accordance with the present disclosure.

FIG. 2 depicts an example computing environment 200 that can include a vehicle 205. The vehicle 205 may include an automotive computer (not shown in FIG. 2). A driver device 220 is shown in FIG. 2, which represents an example device used by the ride share driver 110 to receive communications, send communications, and provide ride share driver services on behalf of the ride share terminal operator 230. The driver device 220, although illustrated as a mobile device, may be another computing device such as a smart watch, laptop computer, tablet, or other mobile device. The driver device 220 may be associated with the ride share driver 110 and/or the vehicle 205.

In one example embodiment, the driver device 220 may connect with other electronic devices using wired and/or wireless communication protocols and transceivers, or may be integrated as part of the vehicle systems such as an infotainment or vehicular computing system. The driver device 220 may be communicatively coupled with the vehicle 205 via one or more network(s) 225, which may communicate via one or more wireless connection(s) and/or may connect with the vehicle 205 directly.

The network(s) 225 illustrate an example communication infrastructure in which the connected devices discussed in various embodiments of this disclosure may communicate. The network(s) 225 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The driver device 220 can include a memory 221 for storing program instructions associated with a ride platform driver application 236 that, when executed by a mobile device processor 223, performs aspects of the disclosed embodiments. The application (or “app”) 235 may be part of the enhanced security ride share system 207, or may provide information to the enhanced security ride share system 207 and/or receive information from the enhanced security ride share system 207.

The ride share passenger 105 is illustrated in FIG. 2 using a passenger device 215, which may be a mobile device as shown in the figure. Similar to the driver device 220, the passenger device 215 may be another mobile device such as a tablet computer, handheld, smart watch or other smart device. The passenger device 215 may include a memory 211 and a processor 210. The memory may include or store program instructions for a passenger application 218.

The vehicle 205, the passenger device 215, and/or the driver device 220 may also receive and/or be in communication with a Global Positioning System (GPS) 275. The GPS 275 may provide a signal or multiple signals receivable by the passenger device 215 and/or the driver device 220, and/or the vehicle 205, which may be usable to determine a present location, speed, trajectory, and other navigation information associated with respective devices. The GPS 275 may be and/or include a satellite system (as depicted in FIG. 2) such as the global navigation satellite system (GLNSS), Galileo, or navigation or other similar system. In other aspects, the GPS 275 may be a terrestrial-based navigation network (not shown in FIG. 2). In some embodiments, the vehicle 205 may utilize a combination of GPS and Dead Reckoning responsive to determining that a threshold number of satellites are not recognized.

In some aspects, the driver device 220 may communicate with the vehicle 205 through the one or more wireless connection(s) (not shown in FIG. 2) that may be encrypted and established between the driver device 220 and a Telematics Control Unit (TCU) (not shown in FIG. 2), which may be included as part of the vehicle 205 systems. The driver device 220 may communicate with the TCU using a wireless transmitter (not shown in FIG. 2) associated with the TCU disposed with the vehicle 205. The transmitter may communicate with the driver device 220 using a wireless communication network such as, for example, the one or more network(s) 225. The wireless connection(s) may communicate via the one or more network(s) 225, and via one or more wireless connection(s) that can be direct connection(s) between the vehicle 205 and the driver device 220. The wireless connection(s) may include various low-energy protocols including, for example, Bluetooth®, Bluetooth® Low-Energy (BLE®), UWB, Near Field Communication (NFC), or other protocols.

The one or more processor(s) 223 and/or 211 may be disposed in communication with one or more memory devices disposed in communication with the respective computing systems (e.g., the memory 221, 210 and/or one or more external databases (not shown in FIG. 2)).

With respect to either of the driver and/or passenger devices 220 and/or 215, the device processor(s) may interact with the device memory storing program code. Considering the driver device 220 for example, the processor(s) 223 may utilize the memory 221 to store programs in code and/or to store data for performing aspects in accordance with the disclosure. The memory 221 may be a non-transitory computer-readable memory storing an enhanced security ride share program code. The memory 221 can include any one or a combination of volatile memory elements (e.g., dynamic random access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc. The passenger device 215 may share similar or identical attributes as the driver device 220.

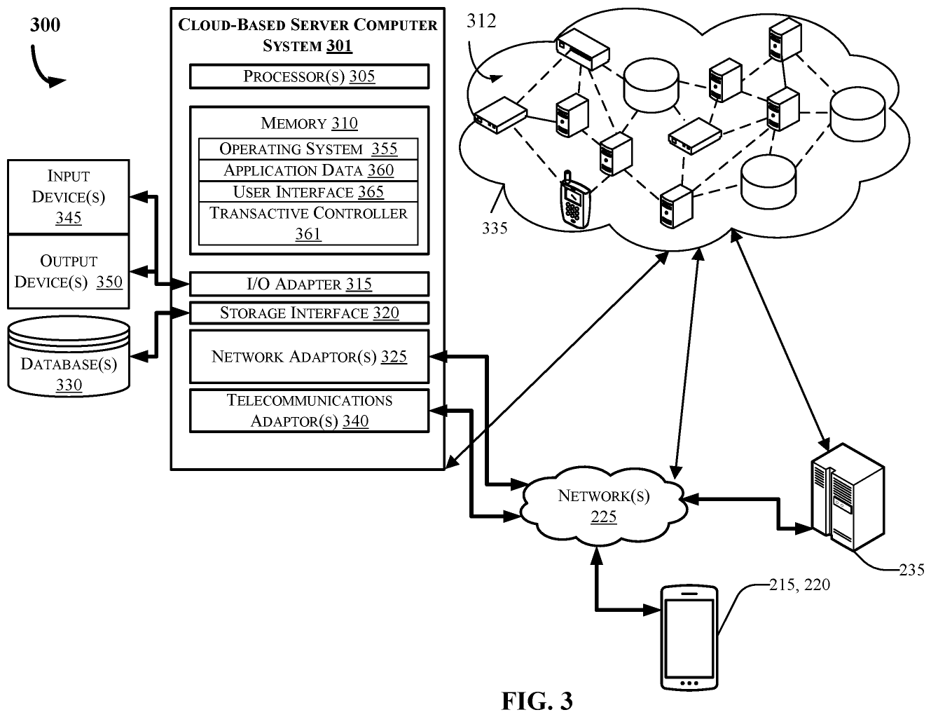

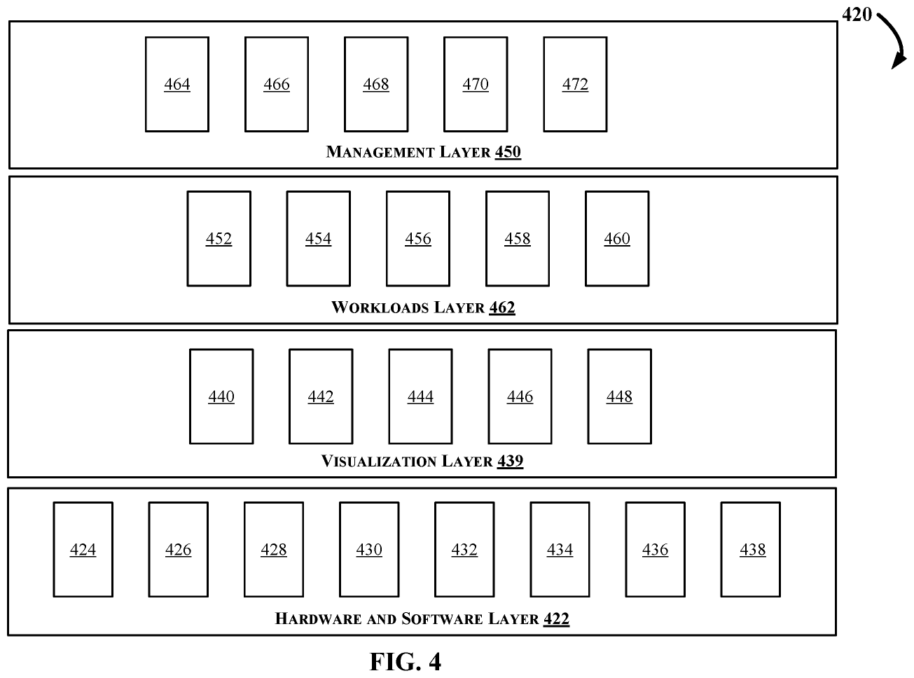

According to embodiments of the present disclosure, the ride share passenger 105 may operate her mobile device (e.g., the passenger device 215) to request a ride using the enhanced security ride share system 207. More particularly, the passenger application 218 may cause the mobile device processor 208 to transmit a passenger request message 222 to a ride share terminal operator 230, which may operate one or more cloud-based server(s) 235 to deliver the enhanced security ride share services. The cloud-based server(s) 235 are discussed in greater detail with respect to FIGS. 3 and 4.

The ride share terminal operator 230 and/or the cloud-based server(s) 235 may be disposed in communication with the passenger device 215, the driver device 220, the vehicle 205, and/or any combination thereof. Accordingly, the passenger device 215 may transmit the passenger request message 222 to the ride share terminal operator 230 via the network(s) 225.

The ride share terminal operator 230 may include a “Pink Ride” service that matches an appropriate ride share driver (e.g., 110) to the ride share passenger 105 based on the passenger request message 222, and further based on the subscription/credit status of the ride share driver 110, as described in greater detail hereafter. Characteristics that may be considered by the system 207 to determine whether or not the ride share driver 110 is appropriate can include one or more of the following: 1) whether the ride share driver 110 has sufficient credits for performing the ride share service (e.g., the ride share driver 110 is not a subscriber for unlimited monthly rides and the ride share driver 110 has not purchased credits that enable him/her to receive a passenger match); 2) whether the ride share driver 110 matches the sex requested (if any) in the passenger request message 222; and 3) whether the ride share driver 110 (and more particularly, the driver device 220) is localized within a geofenced region proximate to the location of the ride share passenger 105. For example, the appropriate geofence diameter may extend to a predetermined number of miles from the passenger pickup location such that the ride share driver 110 may reach the passenger's location in a reasonable time frame. A reasonable time frame may be pre-set and static.

In other aspects, and according to an embodiment, the ride share terminal operator 230 may change the predetermined geofence diameter (not shown in FIG. 2) based on time factors that may be included in the passenger request message 222. For example, the ride share request message 222 may indicate that the ride share passenger 105 is in a particular hurry for a ride, which may require a close by the ride share driver 110.

In some aspects, the passenger request message 232 may include a request for a female driver, in addition to including payment credential information, present location and/or pick up location, destination information, payment information, and/or other data. The ride share driver 110 may be an appropriate match further based on the ride share request message 222 and the sex of the ride share driver 110. In similar circumstances, the ride share driver 110 may be a female that prefers or requests only to be matched with other female passengers as she (the ride share driver 110) provides the service. Accordingly, the driver application 236 may include a user-selectable option to request only female ride share passengers 105.

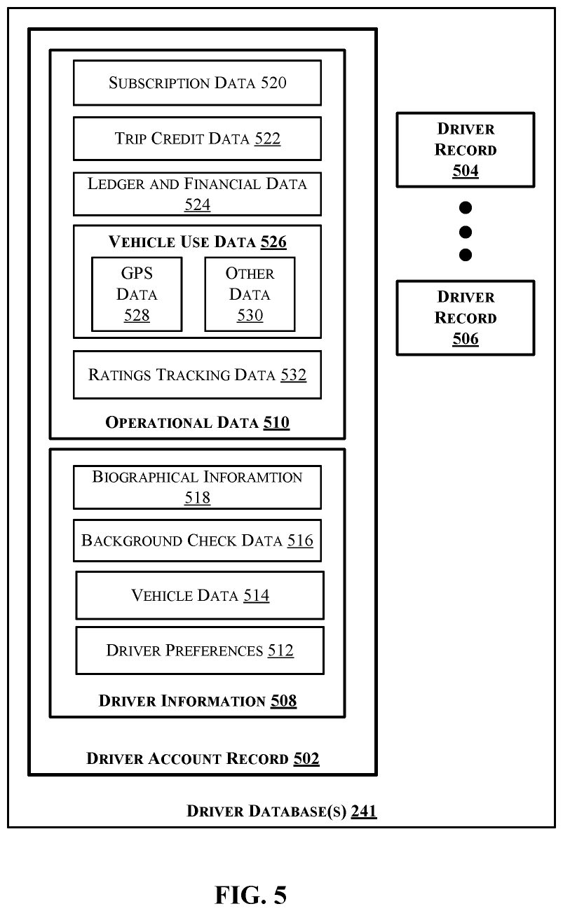

The rider information may be stored in one or more of the cloud-based server(s) 235 as a passenger profile dataset 238. The passenger profile dataset 238 may include passenger profile and biographical information such as name, address, payment information, gender, preferences, passenger ratings, user history, location and travel history, etc. The cloud-based server(s) 235 may further store a driver database 241 (discussed hereafter with respect to FIG. 5).

According to another embodiment, the driver application 236 and/or the passenger application 218 may include user-selectable options for deviation from a preference for driver/passenger gender based on available circumstances. If there are no alternative drivers in the region, for example, the ride share terminal operator 230 may cause the passenger application 218 to output a user-selectable option to provide a male driver if no female drivers are available.

The ride share terminal operator 230 may forward the message to the driver device 220 responsive to determining that the ride share driver 110 is an appropriate match for the location and preferences included in the ride share request message 222. The ride share driver 110 may evaluate the transportation request, and provide a passenger request response 239 via the application 236 if he/she is going to accept or decline the request. The request response 239 may be received by the ride share terminal operator 230.

In the case where the ride share driver 110 accepts the pickup request, the ride share driver 110 may then navigate to the designated passenger pick up location indicated in the passenger request message 222 and complete the transportation service.

The ride share terminal operator 230 may further include, as part of the ride share system 207, a “Safer Ride” service in which a real-time video feed is taken from within the vehicle 205 interior using an RGB camera (not shown in FIG. 2) and/or the driver device 220. For example, the ride share system 207 may obtain video footage of the ride that shown in the camera frame a view of the ride share driver 110 and/or the ride share passenger 105 as the ride share driver 110 proceeds to the drop off point. The ride share system 207 may transmit the video feed to the cloud-based server(s) 235 for safe storage. In one aspect, the video footage may be retrieved, reviewed, downloaded, etc. by one or more of the ride share driver 110 and/or the ride share passenger 105. Because the video feed is received and stored by the ride share terminal operator 230, the video feed is secure and free of risk from deletion by a bad actor, loss due to crashes, damages, time, negligence, or because of other factors. The Safer Ride feature may provide peace of mind and enhanced security for both the ride share passenger 105 and the ride share driver 110.

At the drop off point, one or more of the ride share driver 110 and/or the passenger may indicate that the ride has been completed. The passenger device 215 (and particularly the passenger application 218 operating on the passenger device 215) may cause the mobile device processor 208 to transmit trip information and payment information (depicted in FIG. 2 as ride share payment 240) to a payment processor 245. The payment processor 245 may be an electronic payment clearinghouse or service that is separate from the ride share terminal operator 230. Examples of current payment processors can include credit card processors such as Visa®, Mastercard, American Express®, Discover®, Venmo®, PayPal®, Square®, Stripe®, etc. The payment processor 245 may receive funds from a passenger payment account 247 in a ride share terminal payment account 249 and deposit the funds directly to a driver payment account 250. It should be noted here that one benefit of the present system 207 includes full payment of the ride share funds directly to the driver payment account 250, where none of the funds are deposited to a ride share terminal operator account 255. Instead, the system 207 may provide payment for the ride share terminal operator 230 by subscription payments and/or ride share driver credits paid by the ride share driver 110.

In one aspect, the system 207 may include the application 236 having a user interface (not shown in FIG. 2) for the ride share driver 110 to purchase either a monthly subscription that allows the ride share driver 110 to provide an unlimited number of ride share rides during a calendar month. In one example embodiment, the system 207 may provide the subscription at a fixed fee (e.g., a flat rate) for the unlimited ride share monthly subscription. The system 207 may store the driver subscription information in a driver account record (e.g., as discussed in greater detail hereafter in the the driver account record 502 shown in FIG. 5 as part of a driver database (241)).

The computing systems and/or architecture of the computing environment 200 described with respect to the enhanced security ride share system 207 may omit certain computing modules. It should be readily understood that the computing environment depicted in FIG. 2 is an example of a possible implementation according to the present disclosure, and thus, it should not be considered limiting or exclusive.

FIG. 3 depicts a functional schematic of a computing environment 300, with which techniques and structures for providing the systems and methods disclosed herein may be implemented. The cloud-based server computer system 301 may be substantially similar or identical to the server(s) 271 as shown in FIG. 2. The environment and system described herein can be implemented in hardware, software (e.g., firmware), or a combination thereof.

As shown in FIG. 3, a cloud-based server computer system 301 may include the one or more processor(s) 305, a memory 310 communicatively coupled to the one or more processor(s) 305, and one or more input/output adapters 315 that can communicatively connect with external devices. The one or more cloud-based server(s) 235 may be substantially similar to, or identical to the cloud-based server computer system 301. The cloud-based server computer system 301 may operatively connect to and communicate information with one or more internal and/or external memory devices such as, for example, one or more databases 330 via a storage interface 320. The databases 330 may include, for example, the driver database 241, a passenger database comprising a plurality of passenger profile datasets (e.g., the dataset 238 as shown in FIG. 2), and/or other information. The cloud-based server computer system 301 may include one or more network communications adapter(s) 325 enabled to communicatively connect the cloud-based server computer system 301 with the one or more network(s) 225.

In some example embodiments, the network 225 may be or include a telecommunications network infrastructure. In such embodiments, the cloud-based server computer system 301 can further include one or more telecommunications adaptor(s) 340. The cloud-based server computer system 301 may further include and/or connect with one or more input device(s) 345 and/or one or more output devices 350 through the I/O adapter(s) 315.

The one or more processor(s) 305 are collectively a hardware device for executing program instructions (aka software), stored in a computer-readable memory (e.g., the memory 310). The one or more processor(s) 305 can be a custom made or commercially available processor, a central processing unit (CPU), a plurality of CPUs, an auxiliary processor among several other processors associated with the cloud-based server computer system 301, a semiconductor-based microprocessor (in the form of a microchip or chip set), or generally any device for executing instructions.

The one or more processor(s) 305 may be disposed in communication with one or more memory devices (e.g., the memory 310 and/or one or more external databases 330, etc.) via a storage interface 320. The storage interface 320 can also connect to one or more memory devices including, without limitation, one or more databases 330, and/or one or more other memory drives (not shown in FIG. 3) including, for example, a removable disc drive, a vehicle computing system memory, cloud storage, etc., employing connection protocols such as serial advanced technology attachment (SATA), integrated drive electronics (IDE), universal serial bus (USB), fiber channel, small computer systems interface (SCSI), etc.

The memory 310 can include any one or a combination of volatile memory elements (e.g., dynamic random access memory (DRAM), synchronous dynamic random access memory (SDRAM), etc.) and can include any one or more nonvolatile memory elements (e.g., erasable programmable read only memory (EPROM), flash memory, electronically erasable programmable read only memory (EEPROM), programmable read only memory (PROM), etc.

The instructions in the memory 310 can include one or more separate programs, each of which can include an ordered listing of computer-executable instructions for implementing logical functions. One instruction set may include, for example, a terminal operator application for providing aspects of the present disclosure. In the example of FIG. 3, the instructions in the memory 310 can further include an operating system 355. The operating system 355 can control the execution of other computer programs such as, for example a transactive controller 361, and may provide scheduling, input-output control, file and data management, memory management, and communication control and related ride share services.

The program instructions stored in the memory 310 can further include application data 360, and instructions for controlling and/or interacting with the computer through a user interface 365 such as, for example, the input device(s) 345.

The I/O adapter 315 can connect a plurality of input devices 345 to the cloud-based server computer system 301. The input devices can include, for example, a keyboard, a mouse, a microphone, a sensor, etc. The output device 350 can include, for example, a display, a speaker, a touchscreen, etc.

The I/O adapter 315 can further include a display adapter coupled to one or more displays. The I/O adapter 315 can be configured to operatively connect one or more input/output (I/O) devices 350 to the cloud-based server computer system 301. For example, the I/O adapter 315 can connect a keyboard and mouse, a touchscreen, a speaker, a haptic output device, or other output device. The output devices 350 can include but are not limited to a printer, a scanner, and/or the like. Other output devices can also be included, although not shown. Finally, the I/O devices connectable to the I/O adapter 315 can further include devices that communicate both inputs and outputs, for instance but are not limited to, a network interface card (NIC) or modulator/demodulator (for accessing other files, devices, systems, or a network), a radio frequency (RF) or other transceiver, a telephonic interface, a bridge, a router, and the like.

According to some example embodiments, the cloud-based server computer system 301 can include a telecommunications adapter 340. The telecommunications adapter 340 can include a global positioning system (GPS), cellular, mobile, and/or other communications protocols for wireless communication.

The network(s) 225 may include and/or be part of a cloud computing environment 335 for delivery of one or more services, platforms, etc., described herein. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing, as used herein, is a model of service delivery for enabling convenient, on-demand network access to a shared pool of configurable computing resources (e.g., network(s), network bandwidth, servers, processing, memory, storage, applications, virtual machines, and services) that can be rapidly provisioned and released with minimal management effort or interaction with a provider of the service. This cloud model can include at least five characteristics, at least four service models, and at least four deployment models.

Characteristics of a cloud computing model may include on-demand self-service tools for users such as the ride share driver 110 and the ride share passenger 105 to utilize with a provided service. A cloud consumer can unilaterally provision computing capabilities, such as server time and network storage (which, in some embodiments, may include data associated with passenger request messages 222, ride share offers, identity information associated with ride share passengers 105, etc.), as needed automatically without requiring human interaction with the ride share terminal operator 230.

Characteristics of a cloud computing model may further include broad network access. For example, capabilities are often available over a network (e.g., one or more network(s) 225, as depicted in FIGS. 2 and 3) and accessed through standard mechanisms that promote use by heterogeneous thin or thick client platforms (e.g., mobile phones, laptops, vehicle infotainment system(s), etc.).

Cloud computing platforms may also include and/or utilize resource pooling such that the ride share terminal operator 230 may provide computing resources to the cloud-based server(s) 235 to serve multiple consumers using a multi-tenant model, with different physical and virtual resources dynamically assigned and reassigned according to demand. For example, the ride share driver 110 may utilize the driver application 236 on the driver device 220, and tens, hundreds, etc. of other ride share drivers (not shown in FIGS. 2 and 3) may also (simultaneously) use similar services that access the same resources on the cloud-based server(s) 235. As another example, the ride share passenger 105 may utilize the passenger application 218 on the passenger device 215, and tens, hundreds, etc. of other ride share passengers (not shown in FIGS. 2 and 3) may also (simultaneously) use similar services that access the same resources on the cloud-based server(s) 235. There is a sense of location independence in the embodiments such that the passenger consumer and/or driver consumer may have no control over or knowledge of the exact location of the provided resources but can be able to specify location at a higher level of abstraction (e.g., country, state, or datacenter).

Cloud computing platforms and infrastructure, such as the cloud-based server(s) 235, for example, may provide Software as a Service (SaaS). SaaS is understood as a capability provided to the consumer (e.g., the ride share passenger 105 and/or the ride share driver 110) to use the provider's application 120 running on a cloud infrastructure. The ride share application(s) such as the driver application 236, the passenger application 218 and the ride share terminal processor application stored in the application data 360 (ride share terminal processor application not shown in FIG. 3) is accessible from various client devices (e.g., the driver device 220, the passenger device 215, one or more automotive computing systems associated with the vehicle 205, etc.) through a thin client interface such as a web browser (e.g., a web-based e-mail client). The ride share driver 110 and/or passenger 105 do not manage or control the underlying cloud infrastructure including the network(s) 225 or servers, operating systems, storage, or even individual application capabilities, with the possible exception of limited user-specific application configuration settings.

The ride share terminal operator 230 may also provide a Platform as a Service (PaaS), which can include a capability provided to the ride share passenger 105 and/or the ride share driver 110 to deploy, onto the cloud infrastructure, consumer-created or acquired applications that are created using programming languages and tools supported by the provider. The consumer does not manage or control the underlying cloud infrastructure including the network(s) 225, operating system 355, or databases 330, but has control over the deployed ride share driver and passenger applications 236 and/or 218.

The network 225 depicts the cloud computing environment 335 for use in practicing the teachings embodied herein. As shown in FIG. 3, the cloud computing environment may include one or more cloud computing nodes 312 with which local computing devices may be used by ride share drivers 110, ride share passengers 105, etc. Example devices may include, for example, the driver device 220, an automotive computer, operational as part of the vehicle 205, etc. In some example embodiments, the cloud computing nodes 312 can communicate data with one another. They can be grouped physically or virtually in the one or more network(s) 225 and/or 155. The various types of groupings may provide an infrastructure, one or more platforms, and/or software as services that a cloud consumer such as the ride share driver 110 and/or the ride share passenger 105 may use independently without necessarily requiring software resources on the client side (e.g., on a local computing device such as the mobile devices 215, 220, the automotive computer, etc.).

It is understood that the types of computing devices shown in FIGS. 2 and 3 are intended to be illustrative only and that the cloud computing nodes 312 and the cloud computing environment 335 can communicate with any type of computerized device over any type of network and/or network addressable connection (e.g., using a web browser).

Referring now to FIG. 4, a set of functional abstraction layers 420 provided by the computing environment 300 is depicted, in accordance with an example embodiment. It should be appreciated that the components, layers, and functions of the abstraction layers 420 depicted are illustrative only, and embodiments of the invention are not limited thereto. As depicted, the following layers and corresponding functions are provided:

A hardware and software layer 422 can include hardware and software components. Examples of hardware components can include, for example, mainframes 424, one or more Reduced Instruction Set Computer (RISC) and/or architecture-based servers 426, one or more servers 428, one or more blade servers 430, one or more storage devices 432, and one or more network(s) and networking components 434. In some embodiments, the software components can also include network application server software 436 and/or database software 438. The cloud-based server(s) 235 and/or the cloud-based server computer system 301 are examples of hardware and software layer 422 device(s).

A virtualization layer 439 can provide an abstraction layer from which the following examples of virtual entities can be provided: virtual servers 440, virtual storage 442, virtual network(s) 444 (which can include virtual private network(s)), virtual applications and operating systems 446, and virtual clients 448.

In one example, a management layer 450 can provide the functions described below. A resource provisioning module 452 can provide dynamic procurement of computing resources and other resources that can be utilized to perform tasks within the computing architecture (depicted generally in FIG. 3). A metering and pricing resource 454 that can provide cost tracking for one or more resources utilized within the cloud computing environment 335, and also provide for billing and invoicing for consumption of these resources. In one example, the metering and pricing resources can include the static pricing structures described with respect to FIGS. 2 and 3. In other aspects, the resource provisioning module 452 may further support dynamic pricing structures, such as surge demand pricing for ride share trips.

A user portal 456 can provide access for consumers and system administrators (not shown in FIG. 4). In some embodiments, a user portal 456 can provide security and/or identity verification for cloud consumer devices (e.g., the driver device 220 and/or the passenger device 215, as shown in FIGS. 2 and 3), as well as protection for data and other resources.

A service level management resource 458 can provide cloud computing resource allocation and management such that required service levels are met.

A service level agreement (SLA) planning and fulfillment resource 460 can provide pre-arrangement for, and procurement of cloud computing resources for which a future requirement is anticipated in accordance with an SLA.

A workloads layer 462 can provide functionality for which the cloud computing environment can be utilized. For example, a workloads layer 462 can include a mapping and navigation resource 464 for providing trip information and navigational information associated with the ride share offer, including providing map information, walking instructions, driving instructions, providing distances, projecting time for travel, etc. A software development and lifecycle management resource 466 may be included, as well as a virtual delivery resource 468, a data analytics processing resource 470, a transaction processing resource 472, and the transactive controller 361, described with respect to FIGS. 3 and 4.

FIG. 5 depicts an example driver database in accordance with the present disclosure. The driver database 241 may include a plurality of driver records such as a driver account record 502, 504, 506 . . . etc. The driver account record 502 may include driver information 508 having driver biographical information 518, background check data 516, vehicle data 514, driver preferences 512, and/or other driver-related information. The driver information 508 may further include operational data 510, which may include subscription data 520 indicative of a number of trip credits a driver has purchased or whether the driver has an active monthly subscription in place, trip credit data 522, ledger and financial data 524 indicative of earnings and other financial data, vehicle use data 526 may include GPS data 528, and other data 530 such as vehicle type, make, model, year, etc. Operational data 510 may further include ratings tracking data 532 indicative of relative user ratings provided by passengers as an observation of the driver's performance.

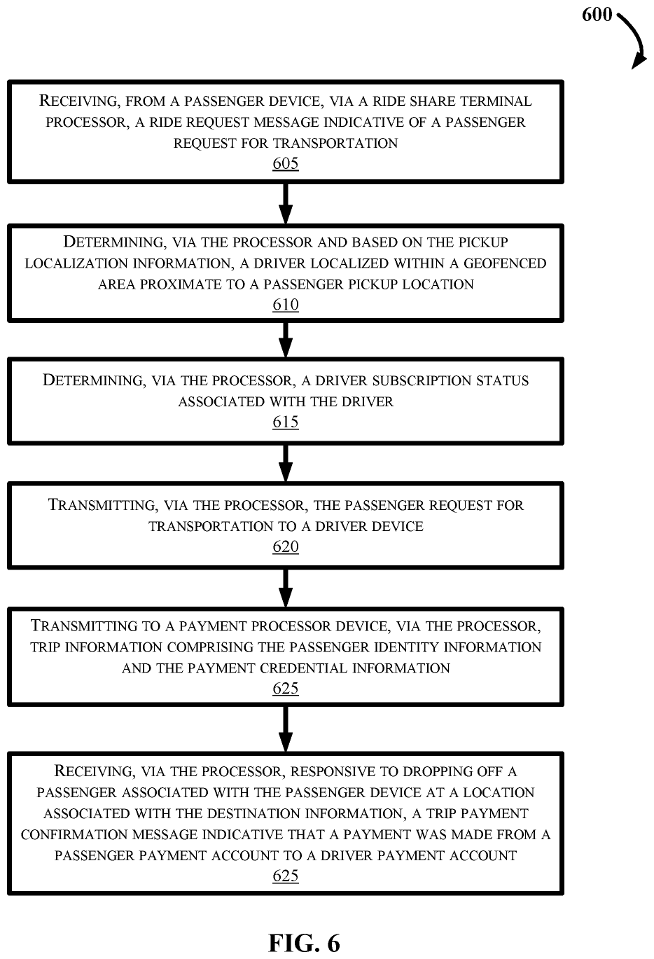

FIG. 6 depicts a flow diagram of an example method for delivering transportation services using a security enhanced ride share platform in accordance with the present disclosure.

Referring now to FIG. 6, at step 605, the method 600 may commence with receiving, from a passenger device, via a ride share terminal processor, a ride request message indicative of a passenger request for transportation. In some aspects, the ride request message comprises passenger identity information, destination information, pickup localization information, and payment credential information. In some aspects, passenger identity information comprises information regarding passenger gender and/or ride share preferences for driver. For example, this information may be indicative that the passenger is female, and the ride request message further comprises a female driver request for a female driver.

At step 610, the method 600 may further include determining, via the processor and based on the pickup localization information, a driver localized within a geofenced area proximate to a passenger pickup location.

At step 615, the method 600 may further include determining, via the processor, a driver subscription status associated with the driver. Determining the driver subscription status comprises determining, via the processor, that a driver profile associated with the driver comprises one of: a value indicative that the driver has purchased a trip credit to provide transportation to the passenger, or a datum indicative that the driver is a monthly subscriber having a monthly subscription that provides an unlimited number of transportation services during a calendar month.

According to another embodiment, this step may include receiving, via the processor, a driver request to purchase the trip credit allowing the driver to provide a single transportation service, receiving, from the payment processor device, a trip credit payment confirmation message indicative that a trip credit payment was made from the driver payment account to a ride share terminal operator account, updating, via the processor and based on the trip credit payment confirmation message, a driver profile dataset associated with the driver with the trip credit, wherein updating comprises adding a trip credit value to show an additional paid trip credit; and removing the trip credit from the driver profile responsive to receiving the trip payment confirmation message.

In other aspects, this step may include receiving, via the processor and from the driver device, a driver request message to purchase the monthly subscription associated with providing unlimited transportation services during the calendar month, receiving, from the payment processor device, a driver subscription credit payment confirmation message indicative that a driver subscription payment was made from the driver payment account to a ride share terminal operator account, and updating, via the processor and based on driver subscription credit payment confirmation message, a driver profile dataset associated with the driver. According to another embodiment, the trip credit payment is a fixed amount (e.g., a flat fee that does not change with regard to distance traveled, time taken, etc.).

At step 620, the method 600 may further include transmitting, via the processor, the passenger request for transportation to a driver device. This step may include determining, responsive to the female driver request, and further based on a driver profile dataset, that the driver is the female driver; and transmitting the passenger request for transportation to the driver device responsive to determining that the driver is the female driver.

At step 625, the method 600 may further include transmitting to a payment processor device, via the processor, trip information comprising the passenger identity information and the payment credential information. The payment credential information may include account number information, login information, name, security passwords, and other information used for online or electronic payment transmission.

At step 630, the method 600 may further include receiving, via the processor, responsive to dropping off a passenger associated with the passenger device at a location associated with the destination information, a trip payment confirmation message indicative that a payment was made from a passenger payment account to a driver payment account. In some aspects, the trip payment confirmation message indicates that all funds charged to the passenger payment account are deposited to the driver payment account. For example, in one embodiment, no funds are charged to the passenger payment account are paid to a ride share terminal operator account associated with a ride share terminal operator.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A computer-implemented method for delivering transportation services, comprising:
receiving, from a passenger device, via a ride share terminal processor, a ride request message indicative of a passenger request for transportation,
wherein the ride request message comprises passenger identity information, destination information, pickup localization information, and payment credential information;
determining, via the processor and based on the pickup localization information, a driver localized within a geofenced area proximate to a passenger pickup location;
determining, via the processor, a driver subscription status associated with the driver;
transmitting, via the processor, the passenger request for transportation to a driver device;
transmitting to a payment processor device, via the processor, trip information comprising the passenger identity information and the payment credential information; and
receiving, via the processor, responsive to dropping off a passenger associated with the passenger device at a location associated with the destination information, a trip payment confirmation message indicative that a payment was made from a passenger payment account to a driver payment account.

2. The method according to claim 1, wherein the trip payment confirmation message indicates that all funds charged to the passenger payment account are deposited to the driver payment account.

3. The method according to claim 1, wherein no funds charged to the passenger payment account are paid to a ride share terminal operator account associated with a ride share terminal operator.

4. The method according to claim 1, wherein the passenger identity information comprises information indicative that the passenger is female, and the ride request message further comprises a female driver request for a female driver.

5. The method according to claim 4, further comprising:
determining, responsive to the female driver request, and further based on a driver profile dataset, that the driver is the female driver; and
transmitting the passenger request for transportation to the driver device responsive to determining that the driver is the female driver.

6. The method according to claim 1, wherein determining the driver subscription status comprises:
determining, via the processor, that a driver profile associated with the driver comprises one of:
a value indicative that the driver has purchased a trip credit to provide transportation to the passenger, or
a datum indicative that the driver is a monthly subscriber having a monthly subscription that provides an unlimited number of transportation services during a calendar month.

7. The method according to claim 6, further comprising:
receiving, via the processor, a driver request to purchase the trip credit allowing the driver to provide a single transportation service;
receiving, from the payment processor device, a trip credit payment confirmation message indicative that a trip credit payment was made from the driver payment account to a ride share terminal operator account;
updating, via the processor and based on the trip credit payment confirmation message, a driver profile dataset associated with the driver with the trip credit, wherein updating comprises adding a trip credit value to show an additional paid trip credit; and
removing the trip credit from the driver profile responsive to receiving the trip payment confirmation message.

8. The method according to claim 6, further comprising
receiving, via the processor and from the driver device, a driver request message to purchase the monthly subscription associated with providing unlimited transportation services during the calendar month;
receiving, from the payment processor device, a driver subscription credit payment confirmation message indicative that a driver subscription payment was made from the driver payment account to a ride share terminal operator account; and
updating, via the processor and based on driver subscription credit payment confirmation message, a driver profile dataset associated with the driver.

9. The method according to claim 7, wherein the trip credit payment is a fixed amount.

10. The method according to claim 8, wherein the driver subscription payment is a fixed amount associated with the monthly subscription.

11. A ride share system, comprising:
a processor; and
a memory for storing executable instructions, the processor programmed to execute the instructions to:
receive, from a passenger device, a ride request message indicative of a passenger request for transportation,
wherein the ride request message comprises passenger identity information, destination information, pickup localization information, and payment credential information;
determine, based on the pickup localization information, a driver localized within a geofenced area proximate to a passenger pickup location;
determine a driver subscription status associated with the driver;
transmit the passenger request for transportation to a driver device;
transmit, to a payment processor device, trip information comprising the passenger identity information and the payment credential information; and
receiving, responsive to dropping off a passenger associated with the passenger device at a location associated with the destination information, a trip payment confirmation message indicative that a payment was made from a passenger payment account to a driver payment account.

12. The ride share system according to claim 11, wherein the trip payment confirmation message is indicative that all funds charged to the passenger payment account are deposited to the driver payment account.

13. The ride share system according to claim 11, wherein no funds charged to the passenger payment account are paid to a transportation services account associated with the ride share system.

14. The ride share system according to claim 11, wherein the passenger identity information comprises information indicative that the passenger is female, and the ride request message further comprises a female driver request for a female driver.

15. The ride share system according to claim 14, wherein the processor is further programmed to execute the instructions to:
determine, responsive to the female driver request, and further based on a driver profile dataset, that the driver is the female driver; and
transmit the passenger request for transportation to the driver device responsive to determining that the driver is the female driver.

16. The ride share system according to claim 11, wherein the processor is further programmed to determine the driver subscription status by executing the instructions to:
determine that a driver profile associated with the driver comprises one of:
a value indicative that the driver has purchased a trip credit to provide transportation services to the passenger, or
a datum indicative that the driver is a monthly subscriber having a monthly subscription that provides an unlimited number of transportation services during a calendar month.

17. The ride share system according to claim 16, wherein the processor is further programmed to execute the instructions to:
receive a driver request to purchase the trip credit allowing the driver to provide a single transportation service;
receive, from the payment processor device, a trip credit payment confirmation message indicative that a trip credit payment was made from the driver payment account to a ride share terminal operator account;
update, based on the trip credit payment confirmation message, a driver profile dataset associated with the driver with the trip credit; and
remove the trip credit from the driver profile responsive to receiving the trip payment confirmation message.

18. The ride share system according to claim 16, wherein the processor is further programmed to execute the instructions to:
receive, from the driver device, a driver request message to purchase the monthly subscription associated with providing unlimited transportation services during the calendar month;
receive, from the payment processor device, a driver subscription credit payment confirmation message indicative that a subscription payment was made from the driver payment account to a ride share terminal operator account; and
update, based on the driver subscription credit payment confirmation message, a driver profile dataset associated with the driver.

19. A non-transitory computer-readable storage medium, the computer-readable storage medium having instructions stored thereupon which, when executed by a processor, cause the processor to:
receive, from a passenger device, a ride request message indicative of a passenger request for transportation,
wherein the ride request message comprises passenger identity information, destination information, pickup localization information, and payment credential information;
determine, based on the pickup localization information, a driver localized within a geofenced area proximate to a passenger pickup location;
determine a driver subscription status associated with the driver;
transmit the passenger request for transportation to a driver device;
transmit, to a payment processor, trip information comprising the passenger identity information and the payment credential information; and
receiving, responsive to dropping off a passenger associated with the passenger device at a location associated with the destination information, a trip payment confirmation indicative that a payment was made from a passenger payment account to a driver payment account.

20. The non-transitory computer-readable storage medium according to claim 19, wherein the trip payment confirmation indicates that all funds charged to the passenger payment account are deposited to the driver payment account.
